(19) United States
(12) Patent Application Publication
(10) Pub. No.: US 2002/0187035 A1
(43) Pub. Date: Dec. 12, 2002

(54) Arrangement for wafer inspection

(75) Inventors: Kersten Schaefer, Jena (DE); Karsten Urban, Jena (DE); Frank Bernhardt, Kahla (DE); Joachim Wienecke, Jena (DE)

Correspondence Address: FOLEY AND LARDNER, SUITE 500, 3000 K STREET NW, WASHINGTON, DC, 20007, US

(73) Assignee: LEICA MICROSYSTEMS JENA GmbH

(21) Appl. No.: 10/133,645

(22) Filed: Apr. 29, 2002

(30) Foreign Application Priority Data
Apr. 28, 2001 (DE) 101 21 044.2

(51) Int. Cl. B65G 1/133

(52) U.S. Cl. 414/749.1

(57) ABSTRACT

The invention concerns an arrangement for wafer inspection, having a device (3) for transporting the wafers (S) from a transfer station (5) to at least one inspection station (7, 9). For transportation of the wafers (S), the device (3) comprises a feeder (4), rotatable about a rotation axis (Z), having at least one wafer support (14) whose position is pivotable, with the rotation of the feeder (4), between the transfer station (5) and inspection station (7, 9); and a drive device (18) that is coupled to the feeder (4) and with the activation of which the feeder (4) is caused to rotate through a predefined reference rotation angle.

According to the present invention, a measurement device (17) for sensing the present actual rotation angle of the feeder (4) with respect to its rotation axis (Z) is provided; also present is a control device (21) for generating a corrective actuating signal from the deviation between the actual rotation angle sensed by the measurement device (17) and the predefined reference rotation angle, and for outputting the corrective actuating signal to the drive device (18).

### CROSS REFERENCE TO RELATED APPLICATIONS

This application claims priority of the German patent application 101 21 044.2 which is incorporated by reference herein.

### FIELD OF THE INVENTION

The invention refers to an arrangement for wafer inspection, having a device for transporting the wafers from a transfer station to at least one inspection station. The device for transporting the wafers (S) encompasses a feeder having at least one wafer support 14 whose position is pivotable, with the rotation of the feeder, between the transfer station and inspection station; and a drive device that is coupled to the feeder and with the activation of which the feeder is caused to rotate through a predefined reference rotation angle.

### BACKGROUND OF THE INVENTION

Arrangements of this kind are used, for example, in semiconductor production, to check the wafer surface optically for manufacturing defects.

An inspection arrangement of the kind cited initially is known from U.S. Pat. No. 5,807,062. In this arrangement, after a wafer is removed from a magazine it is placed on a feeder in a transfer station by means of a robot arm. After orientation of the wafer into a wafer placement position determined in defined fashion, the feeder (also called the wafer holder or substrate holder) is rotated through a predefined rotation angle of 120°, whereupon the wafer is located in a micro-inspection station. Here the wafer is placed on a specimen stage and visually examined by means of a microscope.

After transfer of the wafer from the specimen stage onto the feeder, the wafer is transported, by advancing the feeder through a rotation angle of 120°, to a further inspection station in which a visual whole-field examination or macro-inspection is performed, with the inspector looking directly at the wafer surface. In a subsequent step the substrate is then, by means of an advance through a rotation angle of another 120°, pivoted from the macro-inspection station back to the transfer station and there removed from the feeder for further processing.

For accurate positioning of the wafer at the transfer station and the two inspection stations, there is provided on the feeder a signal disk that comprises windows associated with the corresponding positions. These windows are scanned by means of a sensor in order to allow evaluation of the rotational position of the feeder in terms of reaching one of the stations. This makes possible, however, only coarse position detection with respect to the rotation axis. In the arrangement according to U.S. Pat. No. 5,807,062 an additional positioning device is therefore provided, which performs a fine positioning operation when the feeder reaches one of the stations. The additional positioning device encompasses two toothed racks that can be temporarily brought into engagement with a gear provided on the feeder, as well as a separate drive device for the toothed racks. This arrangement is comparatively complex.

### SUMMARY OF THE INVENTION

Proceeding therefrom, it is the object of the invention to develop an arrangement for wafer inspection of the kind described above in such a way that positioning of the wafers at individual inspection stations is achieved with at least the same accuracy, but with less complexity.

This object is achieved by way of an arrangement of the kind cited initially that is equipped with a measurement device for sensing the present actual rotation angle of the feeder with respect to its rotation axis, and with a control device for generating a corrective actuating signal from the deviation between the actual rotation angle sensed by the measurement device and the predefined reference rotation angle, provision being made for output of the corrective actuating signal to the drive device.

The manner according to the present invention of achieving the object allows highly accurate transmission of wafer-related position coordinates from a transfer station to one or more inspection stations, and from them back again to the transfer station. Because the present angular position of the feeder is constantly being sensed, systematic errors resulting e.g. from mechanical wear, length changes in response to temperature fluctuations, and similar influences, are avoided. In addition, constant sensing of the present rotation angle and thus of the present feeder position makes possible, in coaction with a reference rotation angle that can be defined at variable magnitudes, highly accurate setting of any desired advance angle, not only from station to station but also with halt positions for the wafer between the transfer station and an inspection station or even between two inspection stations.

This also makes possible compensation for a wafer's positional deviations from its reference position on the wafer support. For example, a wafer may be placed with an inaccurate orientation on a displaceable stage or a turntable. If a device that senses this inaccuracy is present, then on the basis of an actuating command ascertained therefrom, which brings about a rotation angle correction, the positional deviation can be immediately compensated for at the next advance step, with no need for additional measurements for the purpose.

In addition, implementation of unrestricted selectability of the advance angle from station to station optionally allows additional functions to be provided in the inspection arrangement, for example by temporary introduction of an additional inspection or transfer station into the standard operation of the arrangement.

The manner according to the present invention of achieving the object is therefore characterized by very high positioning flexibility together with high accuracy.

The drive device can be implemented, for example, by way of an electric or pneumatic drive. Preferably, however, the drive device comprises a stepping motor, with which particularly high positioning accuracies can be attained.

Transfer of torque from the drive device to the feeder can be accomplished, in principle, coaxially with the rotation axis of the feeder, so that a directly coupling is conceivable. Preferably, however, the output shaft of the drive motor is arranged eccentrically with respect to the rotation axis of the feeder. This allows the overall height of the arrangement to be kept low. This is advantageous in terms of the physical conditions of an arrangement for wafer inspection, since it is thereby easy to guarantee an ergonomic viewing position for macro-inspection, in which a wafer can be inspected by an inspector by direct visual observation.

A toothed belt, with which almost entirely slip-free transfer of rotary motion to the feeder can be achieved, is preferably provided for coupling the eccentric drive device to the feeder. A zero-backlash gear drive can also, however, be used instead of the toothed belt.

To improve positioning accuracy further, the measurement device comprises a high-resolution encoder that preferably is provided directly on the feeder. With this, the feeder can be very accurately positioned in any desired position without the use of any mechanical stops whatsoever. Given a spacing of 205 mm from rotation axis Z, a wafer placement accuracy of approximately 3 μm is achieved. This corresponds to a theoretical angular accuracy of 0.0083°.

In a further advantageous embodiment of the invention, the feeder has holding arms each possessing at its end a support for a wafer. The rotational mass of the feeder can thereby be kept low, even in the context of larger distances between the wafer support and the rotation axis.

Preferably the number of holding arms is identical to the number of stations, so that multiple wafers can be transported simultaneously.

In this connection, it is further advantageous if the holding arms are arranged in equally spaced fashion, i.e. radially symmetrically, around the rotation axis. The feeder is thus easy to balance. A correspondingly radially symmetrical arrangement of the stations furthermore makes possible particularly efficient handling of the wafers, so that a cycled operating mode in which multiple wafers can be transported simultaneously can be implemented.

The holding arms preferably each have, at the wafer placement position, a bracket in the shape of a C or a three-quarter circle, the open side of which faces, for example, in the direction of rotation.

In a further advantageous embodiment of the invention, means are provided for individual manual definition of a reference rotation angle. The movement of the feeder can thereby be controlled separately for individual wafers. This is advantageous, for example, if wafer-related repositioning needs to be performed at the individual stations or at measurement devices provided there.

The modifiability of the reference rotation angle can furthermore be utilized for automatic position correction of the wafer. For that purpose, the control device comprises means for calculating the reference rotation angle as a function of an automatically sensed position of a wafer on the support. In some circumstances it is also thereby possible, as already stated above, to compensate for positional deviations of a wafer.

### BRIEF DESCRIPTION OF THE DRAWINGS

The invention will be explained in further detail below with reference to an exemplary embodiment depicted in the drawings, in which:

FIG. 1 is a schematic depiction of an arrangement for wafer inspection having a feeder for transporting the wafer between individual stations of the arrangement; and

FIG. 2 is a perspective view of the arrangement for wafer positioning according to the exemplary embodiment.

### DETAILED DESCRIPTION OF THE INVENTION

The exemplary embodiment shows an inspection arrangement 1 with which wafers S of various diameters can be examined. In particular, inspection arrangement 1 can be used to examine in more detail those wafers rejected as defective during semiconductor manufacture, in order to identify defect sources. Inspection arrangement 1 is not, however, limited to that purpose alone, but rather can be used generally for the inspection of wafers S.

For this purpose, several stations at which different tasks are performed are located within a housing 2. In the exemplary embodiment depicted, a total of three such stations are provided, arranged spaced apart from one another around a common center. Transportation of wafers S between the stations is accomplished by means of a transfer device 3 that comprises a feeder 4 rotatable about a rotation axis Z.

A first station serves as transfer station 5 in which, by means of a transfer device 6 not depicted in further graphic detail, individual wafers S can be placed onto or removed from a wafer support 14 that is located on the radially outwardly directed end of a holding arm 13 protruding from rotation axis Z. One or even more magazines to be loaded with wafers can be present for that purpose in transfer device 6. In that context, the wafers to be examined can be collected in a first magazine, and the wafers already examined in a further magazine. It is also conceivable to place the examined wafers S into different magazines in accordance with definable quality criteria.

A second station may be provided as macro-inspection station 7. When a wafer S is located in this macro-inspection station 7, an inspector P standing or sitting next to inspection arrangement 1 can then directly visually inspect wafers S that are to be examined. In this macro-inspection it is possible, in particular, to detect larger defects such as scratches or also contaminants deposited on wafer S even before a microscopic inspection is performed. The latter can then optionally be omitted.

A so-called wobbler can optionally be arranged in macro-inspection station 7. This comprises, inter alia, a turntable having a mount for wafer S. This turntable (not depicted here in further detail) is rotatable about an axis. The turntable can also be inclined with respect to the rotation axis so that upon rotation of the turntable, a wafer S placed thereon performs a tumbling motion. With suitable illumination of wafer S located on the turntable, the inspector can easily detect gross surface defects on wafer S.

It is furthermore possible to arrange in macro-inspection station 7 a gripper with which wafer S can be grasped at its edge and turned over for observation of the reverse side, without touching the patterned surface of wafer S. It is additionally possible, by reading out an identification marking present on wafer S, to perform an identification thereof in one of the two aforesaid stations 5 or 7.

The microscopic inspection already mentioned is accomplished in a third station, micro-inspection station 9. For that purpose a microscope 10, whose microscope viewing port 11 is accessible to inspector P, is arranged inside housing 2. Microscope 10 further comprises a stage 12 that is linearly displaceable in an X-Y plane perpendicular to rotation axis Z. Wafer S that is to be examined is placed on that stage 12. By displacement of stage 12, selected portions of wafer S can then be viewed more closely using microscope 10.

It is immediately evident that for highly accurate transfer of position information between the individual stations, stringent requirements must be applied in terms of the positioning accuracy of transfer device 3; this will be explained in more detail below. In particular, highly accurate transfer of position information allows coordinates to be transferred from station to station with no need to determine the actual position of wafer S again in each individual station. The resulting elimination of correction actions for repositioning the wafer at individual stations results in time savings, and thus in enhanced productivity in wafer manufacture.

Transfer device 3 comprises feeder 4 already mentioned, which comprises three wafer supports 14 each for one wafer S. The individual wafer supports 14 are located at the radially outwardly directed ends of holding arms 13. The three holding arms 13 are arranged immovably with respect to one another around rotation axis Z at equal spacings of 120° each.

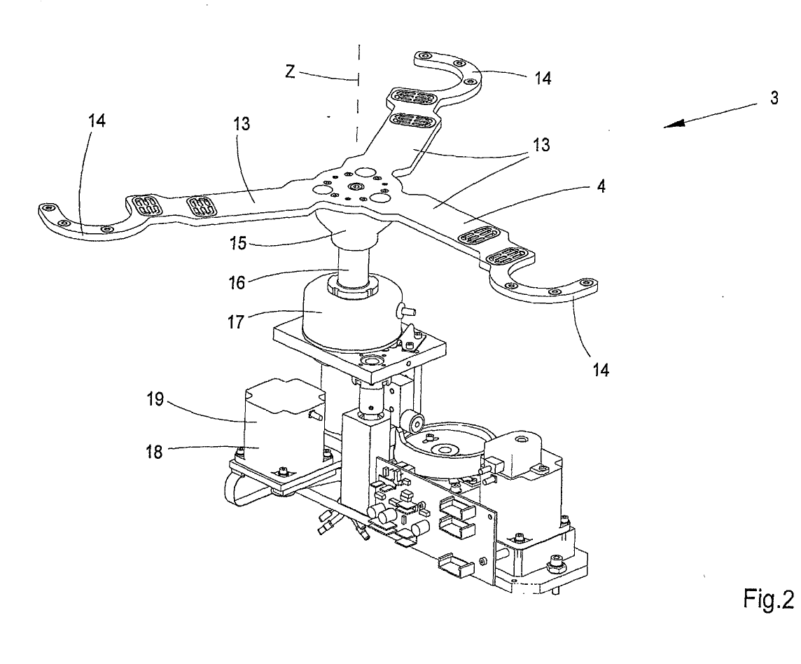

Wafer supports 14 are configured, for example, as C-shaped brackets (cf. FIG. 2) on which wafers S can be placed. The arrangement of the individual holding arms 13 corresponds to the arrangement of stations 5, 7, and 9. As a result, wafer supports 14 simultaneously reach one of the three stations 5, 7, and 9, thus making possible cycled operation of transfer device 3.

It is evident from FIG. 2 that feeder 4 furthermore comprises a shaft 16 that is immovably joined to a hub 15 on which holding arms 13 are mounted. Provided around shaft 16 is a measurement device 17, in the form of a high-resolution encoder, for sensing the angular position of feeder 4 with reference to rotation axis Z. This allows the actual present angular position of feeder 4 to be picked off directly.

In addition, transfer device 3 comprises a drive device 18 in order to rotate feeder 4 about its rotation axis Z and thereby make possible an angular advance between the stations or any intermediate positions. Drive device 18 comprises a stepping motor 19 that is arranged outside rotation axis Z in order to minimize the physical height of transfer device 3. The rotational motion of stepping motor 19 is transferred to feeder 4 in slip-free fashion by means of a toothed belt (not depicted).

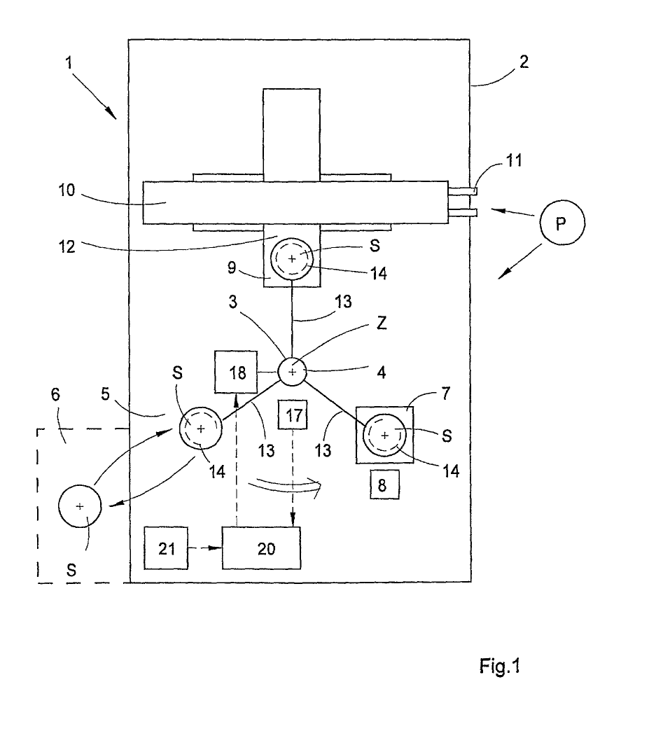

Drive device 18 is actuated via a control device 20 (see FIG. 1) that is linked to measurement device 17. In control device 20, the angular position measured with measurement device 17 is evaluated, and furthermore a control output for drive device 18 is generated as a function of a predefined but modifiable reference rotation angle. Positional deviations of feeder 4 measured during operation can be taken into account and compensated for in defining the reference rotation angle. It is additionally possible, by sensing the position of wafer S, to identify any positional deviation thereof and to correct it by means of the modified definition of the reference rotation angle.

It is also possible to define the reference rotation angle as a command variable to which feeder 4, or a wafer S present thereon, is regulated. Any angular positions, including between the stations, can be arrived at in controlled fashion in this context.

Also provided are input means 21 for manual definition of the reference rotation angle, which are linked to control device 20 (FIG. 1). The rotational motion of transfer device 3 can thereby be manipulated as desired. This is useful, for example, when devices in the individual stations 5, 7, 9 are to be adjusted or aligned.

The passage of a wafer S through inspection arrangement 1 described above will be explained below.

Firstly, a wafer S is removed from a magazine by means of transfer device 6 and placed on wafer support 14 of a holding arm 13 of feeder 4. As a result of a 120° rotation of feeder 4 about rotation axis Z, this wafer S arrives at macro-inspection station 7. There wafer S is temporarily placed on a turntable. By means of a rotation of the turntable, an identification marking present on wafer S can be located and read out in coaction with device 8. In addition, the patterned surface S of the wafer can be visually inspected by generating a tumbling motion. Wafer S can optionally be turned over in order to view its reverse side.

After completion of these operations, wafer S is transferred back to feeder 4, whereupon the latter transports wafer S into micro-inspection station 9. There wafer S is temporarily placed on stage 12 of microscope 10 so that individual portions of wafer S can be examined microscopically. This examination is followed by transport back to transfer position 5. There wafer S is removed with transfer device 6 and placed in a magazine.

If it is found during the macro-inspection that a micro-inspection of wafer S is no longer necessary, micro-inspection station 9 is bypassed by direct transport of wafer S. Alternatively, wafer S can also be transported over a shorter distance directly back to transfer station 6, for which purpose feeder 4 is rotated in the opposite direction.

Because the rotation angle of transfer device 3 is unrestrictedly selectable, wafer S can also be halted in any desired intermediate position between the individual stations 5, 7, and 9. It is possible, for example, temporarily to provide one or even several additional stations in which regular or optional additional inspections are performed.

The inspection arrangement described above is characterized by the great flexibility of its transfer device 3, since unrestrictedly selectable rotation angles are possible together with highly accurate transfer of the position coordinates of a wafer S between the halt positions.

PARTS LIST

| | |
|---|---|
| 1 | Inspection arrangement |
| 2 | Housing |
| 3 | Transfer device |
| 4 | Feeder |
| 5 | Transfer station |
| 6 | Transfer device |
| 7 | Macro-inspection station |
| 8 | Device for identifying substrates and measuring positional deviation |
| 9 | Micro-inspection station |
| 10 | Microscope |
| 11 | Microscope viewing port |
| 12 | Stage |
| 13 | Holding arm |
| 14 | Wafer support |
| 15 | Hub |
| 16 | Shaft |
| 17 | Measurement device |
| 18 | Drive device |
| 19 | Stepping motor |
| 20 | Control device |
| 21 | Input means |
| S | Substrate |
| Z | Rotation axis |
| P | Inspector |

What is claimed is:

1. An arrangement for wafer inspection, having a device for transporting the wafers from a transfer station to at least one inspection station, comprising
a feeder, rotatable about a rotation axis, having at least one wafer support whose position is pivotable, with the rotation of the feeder, between the transfer station and inspection station;
a drive device that is coupled to the feeder and with the activation of which the feeder is caused to rotate through a predefined reference rotation angle;
a measurement device for sensing the present actual rotation angle of the feeder with respect to its rotation axis; and
a control device for generating a corrective actuating signal from the deviation between the actual rotation angle sensed by the measurement device and the predefined reference rotation angle, and for outputting the corrective actuating signal to the drive device.

2. The arrangement as defined in claim 1, wherein the drive device comprises a stepping motor with high-resolution rotation angle positioning.

3. The arrangement as defined in claim 1, wherein the output shaft of the stepping motor is arranged extra-axially parallel to the rotation axis of the feeder.

4. The arrangement as defined in claim 3, wherein the output shaft of the stepping motor is coupled to the rotation axis of the feeder via a toothed belt.

5. The arrangement as defined in claim 1, wherein a high-resolution angle sensor, whose signal output is connected to the signal input of the control device, is provided as the measurement device.

6. The arrangement as defined in claim 5, wherein the measured value transducer of the angle sensor is rigidly joined to the rotation axis of the feeder.

7. The arrangement as defined in claim 1, wherein the feeder has multiple holding arms, protruding from the rotation axis, on each of whose radially outwardly directed ends a wafer support is present.

8. The arrangement as defined in claim 7, wherein the number of holding arms corresponds to the number of transfer and inspection stations.

9. The arrangement as defined in claim 7, wherein the holding arms are arranged radially symmetrically around the rotation axis.

10. The arrangement as defined in claim 1, wherein means are provided for manual definition of the reference rotation angle.

11. The arrangement as defined in claim 1, wherein the wafer supports are configured approximately in the shape of a three-quarter circle, such that when in place, a wafer approximately coaxially covers the three-quarter circle.

12. The arrangement as defined in claim 1, wherein means for sensing the eccentric placement position of a wafer on the wafer support are present, and the control device possesses means for calculating the reference rotation angle to the respective next transfer or inspection station as a function of the eccentric placement position.
